(19) United States
(12) Patent Application Publication
(10) Pub. No.: US 2005/0031404 A1
(43) Pub. Date: Feb. 10, 2005

(54) Car wash device

(75) Inventors: John Tsai, Cheshire, CT (US); Eugene Tsai, Fort Wayne, IN (US); Charles Tsai, Fort Wayne, IN (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Jet Air Industries, Cheshire, CT (US)

(21) Appl. No.: 10/621,144

(22) Filed: Jul. 16, 2003

(51) Int. Cl. B43K 5/02

(52) U.S. Cl. 401/188 R; 401/281

(57) ABSTRACT

A car wash device includes a vessel, pump, brush, hose, flow control device and fittings. The brush has a nozzle. The hose is matable to the brush and to the vessel. The brush is matable to both the hose for the vessel and a high pressure water source. A flow control device has a low pressure position for use when the brush is mated to the vessel and a high pressure position when the brush is mated to the high pressure water source. Liquid may be pressurized by the pump and flow from the vessel and through the nozzle for use when the flow control device is in the low pressure position. Alternatively, water flows from the high pressure water source through the nozzle for use when the flow control device is in the high pressure position. A brush for the car wash device is also provided.

### BACKGROUND OF THE INVENTION

This invention relates generally to a car wash device. More particularly, the present invention relates to a car wash device that may operate at low pressure.

Numerous patents are known that are directed to various car wash devices. Many of these prior art patents disclose use of a vessel in which a cleaning fluid is contained where the cleaning fluid is ultimately provided to a spray nozzle. For example, U.S. Pat. No. 5,100,058 (Wei) teaches a self-contained cleaning system for use with motor vehicles that includes a storage tank filled with cleaning fluid that is pumped, via an electric motor, through a hose to a pistol-shaped sprayer head. Depressing a trigger on the sprayer head opens a valve and activates an electric motor which drives the pump to send the cleaning fluid through the hose to the sprayer head. The cleaning fluid is emitted from a nozzle having a rotatable nozzle outlet selector.

Similarly, U.S. Pat. No. 6,394,683 (Pao) discloses a floor mop with a pressurized sprayer. A backpack tank holds a cleaning solution connected by a tube to a sprayer nozzle at the end of an elongate shaft. The tank is pressurized by a pressurizing pump. A sprayer control valve controls spraying.

Additionally, U.S. Pat. No. 6,550,998 (Fernschild. et al.) teaches a device for applying a fluid to a surface. The device includes a container for the fluid with an opening at its lower end. The container is held on the user's back and gravity provides for the fluid within the container to move through a hose to a mopping or applicator device. Operation of the system relies on gravity to allow the liquid to flow.

Finally, U.S. Pat. No. 6,227,744 (Fodrocy, et al.) is directed to a liquid dispensing mechanism contained in the handle of a cleaning implement. The handle includes a chamber for holding a liquid. A push button activator introduces air into the chamber such that when air is introduced into the air tight chamber through a valve assembly, an amount of liquid corresponding to the amount of air introduced is dispensed from the chamber and out from the handle through a dispensing outlet.

Another similar device that does not use a separate vessel is disclosed in U.S. Pat. No. 5,975,423 (Rice et al.) which teaches a portable, fully self-contained pressure wash-down system that includes a pump disposed in a container that includes a low pressure inlet for delivering low pressure water to the pump and a high pressure outlet for delivering pressurized water from the pump. The system includes an intake line having first and second ends, where the first end of the intake line receives water from a water source and the second end is connected to the pump inlet. Water is pumped from the water source to a hand-held sprayer.

All references cited herein are incorporated herein by reference in their entireties.

### BRIEF SUMMARY OF THE INVENTION

A preferred embodiment of the present invention is directed to a car wash device that includes a vessel for holding a liquid, a pump to pressurize the vessel, a brush having a nozzle where the nozzle is sealingly connected to a brush hose fitting, a hose having a first end and a second end wherein the first end of the hose sealingly matable to the brush hose fitting and the second end of the hose is sealingly mated to the vessel, and a flow control device for controlling flow of the liquid through the nozzle. The flow control device has at least a low pressure position for use when the hose is mated to the vessel. The liquid is pressurized by the pump to cause the liquid to flow from the vessel through the hose and through the nozzle.

Preferably, the brush has a hollow elongate handle. The nozzle may be sealingly connected to the hollow elongate handle at a first end of the elongate handle, and the brush hose fitting may be located at a second end of the elongate handle. The flow control device is preferably integral to the nozzle. The vessel may have a pressure relief valve. The flow control device may have several detent positions for different flow pressures. A valve may be included for controlling flow of liquid through the nozzle. The nozzle may have selectable nozzle shapes for selection of a nozzle flow pattern exiting the nozzle. The nozzle may have a rotatable selector disk that provides for selection of one of the nozzle shapes. The pump may be, for example, a manually powered air pump or an electrically powered pump. Finally, the flow control device may have a hole in the brush that is matable to one of a plurality of plugs having an orifice.

Another preferred embodiment of the present invention is directed to a car wash device that includes a vessel for holding a liquid, a pump for pressurizing the vessel, a brush, a hose, a flow control device and various fittings. The brush has a nozzle that is sealed to a brush hose fitting. The hose has a first end and a second end, wherein the first end of the hose has a first hose fitting that is detachably and sealingly matable to the brush hose fitting and wherein the second end of the hose is sealingly mated to the vessel (with or without a fitting). The brush hose fitting is sealingly matable to either the first hose fitting or a high pressure water source hose fitting. A flow control device for controlling flow of the liquid through the nozzle has at least a low pressure position for use when the hose is mated to the vessel and a high pressure position when the hose is mated to the high pressure water source hose fitting. When the brush hose fitting is mated to the first hose fitting of the hose, the liquid may be pressurized by the pump to cause the liquid to flow from the vessel through the hose and through the nozzle when the flow control device is in the low pressure position. When the brush hose fitting is mated to the high pressure water source hose fitting, water may flow from the high pressure water source through the hose and through the nozzle when the flow control device is in the high pressure position.

Preferably, the brush has a hollow elongate handle. Preferably, the nozzle is sealingly connected to the hollow elongate handle at a first end of the elongate handle, and the brush hose fitting is located at a second end of the elongate handle. The flow control device may or may not be integral to the nozzle. The flow control device may have detent positions to select either the high pressure position or the low pressure position.

Optionally, the vessel may have a pressure relief valve. A valve for controlling flow of liquid through the nozzle may also be included. The nozzle may be of a form that has several selectable nozzle shapes for selection of a nozzle flow pattern exiting the nozzle. The nozzle may have a rotatable selector disk that provides for selection of one of the nozzle shapes. These nozzle shapes may provide appropriate pressure for the high pressure positions and low pressure positions.

The pump is preferably a manually powered air pump, but may be another type of pump such as an electric pump.

Alternatively, the flow control device may be a hole in the brush that is matable to one of a several of plugs having orifices. The plugs here would include at least a low pressure plug (i.e., having an appropriately shaped orifice for low pressure) for use when the hose is mated to the vessel and a high pressure plug (i.e., having an appropriately shaped orifice for high pressure) for use when the hose is mated to the high pressure water source hose fitting.

A brush for a car wash device is also provided which includes a body, a nozzle sealingly connected to a brush hose fitting, and a flow control device for controlling flow of a liquid through the nozzle. The flow control device may have at least a low pressure position and a high pressure position. The nozzle may provide for a flowrate in the range of, for example, about 0.4 gallons per minute at 40 psi to about 0.8 gallons per minute at 40 psi. Preferably, the brush has a hollow elongate handle. The nozzle is preferably sealingly connected to the hollow elongate handle at a first end of the elongate handle, and a brush hose fitting is located at a second end of the elongate handle. The flow control device is preferably integral to the nozzle. The flow control device may have a plurality of detent positions. A valve for controlling flow of liquid through the nozzle may be included. The nozzle may have selectable nozzle shapes for selection of a nozzle flow pattern exiting the nozzle. The nozzle may have a rotatable selector disk that provides for selection of one of the nozzle shapes. The flow control device may include a hole in the brush that is matable to one of a several plugs having an orifice. The plugs may include at least a low pressure plug and a high pressure plug.

### BRIEF DESCRIPTION OF SEVERAL VIEWS OF THE DRAWINGS

The invention will be described in conjunction with the following drawings in which like reference numerals designate like elements and wherein:

FIG. 1 is a side, elevational view of a car wash device in accordance with one preferred embodiment of the present invention.

FIG. 1A is a side, elevational view of a detail of a brush of the car wash device of FIG. 1, designated as “FIG. 1A” in FIG. 1.

FIG. 2 is an isometric view of a nozzle located on the brush of the car wash device of FIG. 1.

FIG. 3 is an exploded, front isometric view of the nozzle of FIG. 2.

FIG. 4 is a an exploded, rear isometric view of the nozzle of FIG. 2.

FIG. 5 is a partial, cross-sectional view of the nozzle of FIG. 2.

FIG. 6 is an isometric view of an alternate nozzle located on an alternate brush similar to that of the car wash device of FIG. 1.

### DETAILED DESCRIPTION OF THE INVENTION

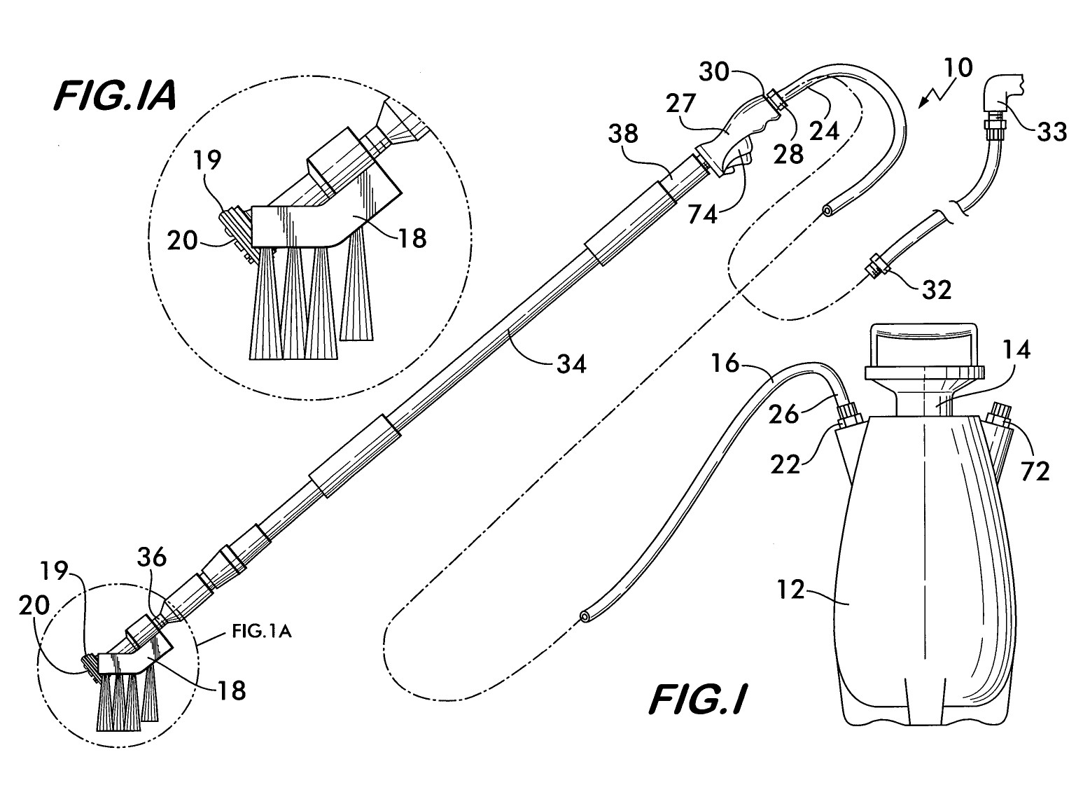

Referring now to the drawings, wherein like part numbers refer to like elements throughout the several views, there is shown in FIG. 1 a car wash device 10 in accordance with one preferred embodiment of the present invention. The car wash device 10 generally includes a vessel 12, a pump 14, a hose 16, a brush 18 having a nozzle 19, a flow control device 20 and various fittings.

The hose 16 has a first end 24 and a second end 26. The first end 24 of the hose 16 has a first hose (male) fitting 28 that is detachably and sealingly matable to a female brush hose fitting 30 (shown internal to handle 27). The second end 26 of the hose 16 is sealingly mated (or matable via a fitting 22) to the vessel 12. It is noted that the brush hose fitting 30 preferably is a standard female domestic garden hose fitting and is sealingly matable to either the first hose fitting 28 or a standard male high pressure water source hose fitting 32.

For purposes of the present invention, the high pressure water source 33 is a common, for example, domestic water source, that uses has a common male household garden hose fitting. The high pressure water source 33 is at a pressure of, for example, 50 to 70 psi.

The pump 14 is capable of pressurizing the vessel 12 to cause liquid contained in the vessel 12 to flow from the vessel 12 through the hose 16 (and its various fittings) to the nozzle 19 on the brush 18. The internal pressure of the vessel may be, for example, 25-35 psi when fully pressurized. The flow control device 20 controls flow of liquid through the nozzle 19. The flow control device 20 may have numerous positions. However, with respect to the preferred embodiment shown here, the flow control device 20 has at least one low pressure position for use when the brush hose fitting 30 is mated via the hose 16 to the vessel 12 and at least one high pressure position for use when the hose 16 is mated to the high pressure water source 33 hose fitting 32. When the brush hose fitting 30 is mated to the first hose fitting 28 of the hose 16, the liquid may be pressurized by the pump 14 to cause the liquid from the vessel 12 to flow from the vessel 12 through the hose 16 and through the nozzle 19 when the flow control device 20 is in a low pressure position. When the brush hose fitting 30 is mated to the high pressure water source hose fitting 32, water may flow from the high pressure water source through the hose 16 and through the nozzle 19 when the flow control device 20 is in the high pressure position. The high pressure positions and the low pressure positions provide for appropriate water pressure to exit the nozzle 19 suitable for washing an automobile. With respect to the low pressure position, an appropriate water pressure would be no more than about 35 psi, with a spray angle of about 50 to 120 degrees.

In a preferred embodiment of the present invention, the brush 18 has a hollow elongate handle 34, having a first end 36 and a second end 38. The handle 34 may be telescopic, to provide a user with extended reach for, for example, the roofs of sport utility vehicles. The first end 36 of the handle 34 may be integral to the brush 18 such that liquid may flow through the hollow handle 34 and through the nozzle 19. Alternatively, the first end 36 of the handle 34 may be detachable from the brush 18, for example, using a threaded and sealed connection (as shown in FIG. 1). Here, the detachable connection still provides for liquid to flow through the handle 34 and then through the nozzle 19. In either case, in the preferred embodiment, the brush hose fitting 30 is sealingly connected to the second end 38 of the handle 34.

As indicated, the flow control device 20 provides at least two different settings, a high pressure position for use when the device 10 is connected to a high pressure water source 33 and a low pressure position for use when the device is connected to its vessel 12. The prior art does not include this beneficial combination.

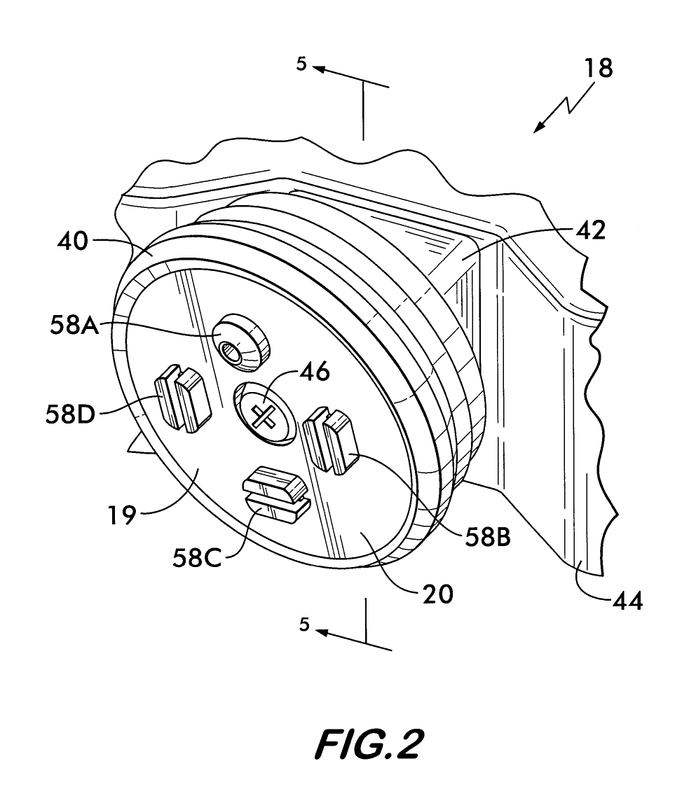

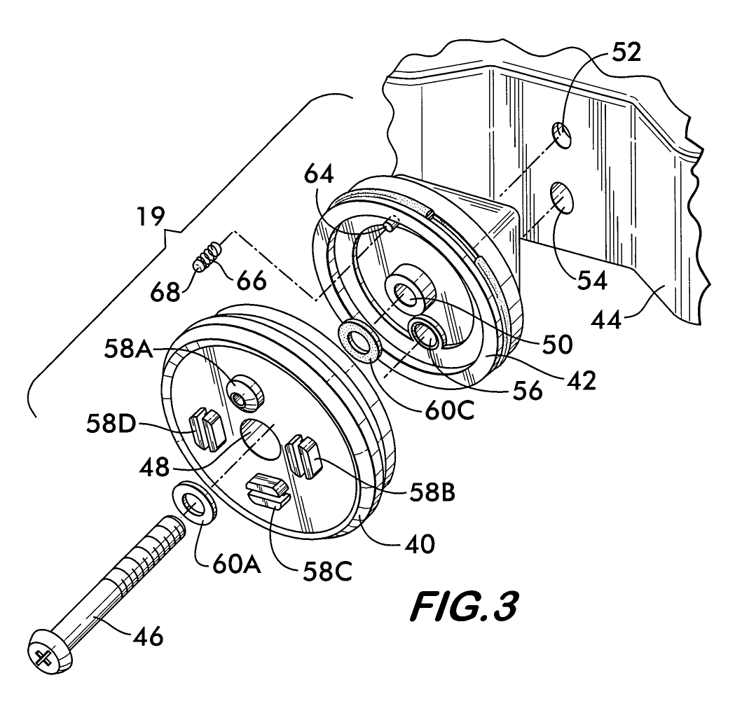

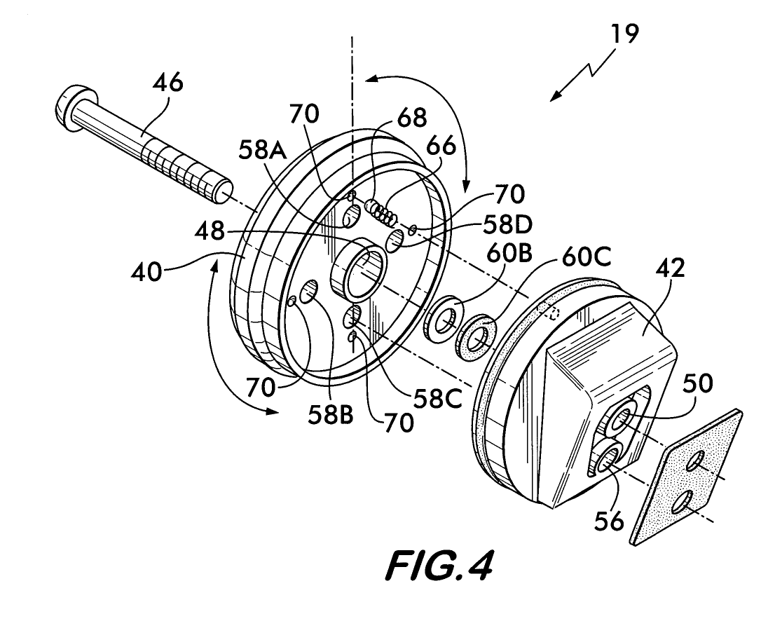

In a preferred embodiment, the flow control device 20 is integral to the nozzle 19. FIGS. 2 through 5 depict various views of a preferred nozzle 19 that provides, in this particular example, two high pressure positions (nozzle outlet holes 58A (jet spray), 58B (flat fan spray) and two low pressure positions (nozzle outlet holes 58C (flat fan spray), 58D (flat fan spray). As can be seen most clearly in FIGS. 3 and 4, the nozzle 19 includes two primary portions, a rotatable nozzle selector disk 40 which mates to a fixed water outlet 42. The fixed water outlet 42 and the rotatable nozzle selector disk 40 are secured to the body 44 of the brush 18 by a centrally located screw 46 about which the rotatable nozzle selector disk 40 rotates relative to the fixed water outlet 42. As can be seen in FIG. 3, the screw 46 is located through a central aperture 48 in the nozzle selector disk 40, through a central aperture 50 in the fixed water outlet 42 and into a threaded hole 52 in the body 44 of the brush 18.

Liquid may pass through liquid aperture 54 in the body 44 of the brush 18, through a liquid aperture 56 in the fixed water outlet 42, and through a selected one of a plurality of different nozzle outlet holes 58A, 58B, 58C, 58D. Washers (e.g., 60A, 60B, 60C) may be used to provide adequate sealing and desired friction characteristics.

It is noted that the fixed water outlet 42 is rigid with respect to the body 44 of the brush 18 while the rotatable nozzle selector disk 40 is rotatable with respect to the fixed water outlet 42. This provides for a user to rotate the nozzle selector disk 40 such that a desired one of the nozzle outlet holes 58A, 58B, 58C, 58D is positioned over the liquid aperture 56 in the fixed water outlet 42 and the liquid aperture 54 in the body 44 of the brush 18. Various washers, gaskets, or the like may be used to provide proper sealing so that the various portions of the car wash device do not leak substantially. See, e.g., FIG. 4.

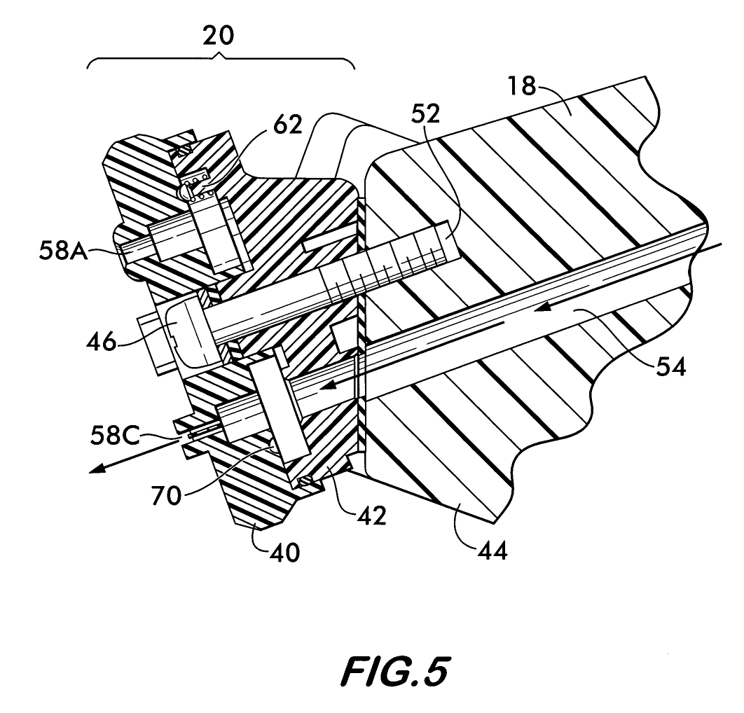

As can best be seen in FIGS. 4 and 5, a detent device 62 may be used to assist in selection of one of the plurality of nozzle outlet holes 58A, 58B, 58C, 58D. In the preferred embodiment, as shown in the figures, the detent device 62 includes a pin 64 located on the fixed water outlet 42, a biasing member, such as a coil spring 66 that surrounds the pin 64, a cap 68 located atop the coil spring 66 and various hemispherical detent indentations 70 in the nozzle selector disk 40. As a user rotates the nozzle selector disk 40, the cap 68 moves in and out of the detent indentations 70 such that when one of the nozzle outlet holes 58A, 58B, 58C, 58D is aligned with the liquid aperture 56 in the fixed water outlet 42, the nozzle selector disk 40 “clicks” into proper position such that the user is aware that the nozzle 19 is set up properly. Again, as described above, at least one of the detent positions is located for nozzle outlet holes 58A, 58B that provide for use of high pressure water and at least one of the detent positions is located for a nozzle outlet holes 58C, 58D that provide for use of the low pressure vessel 12.

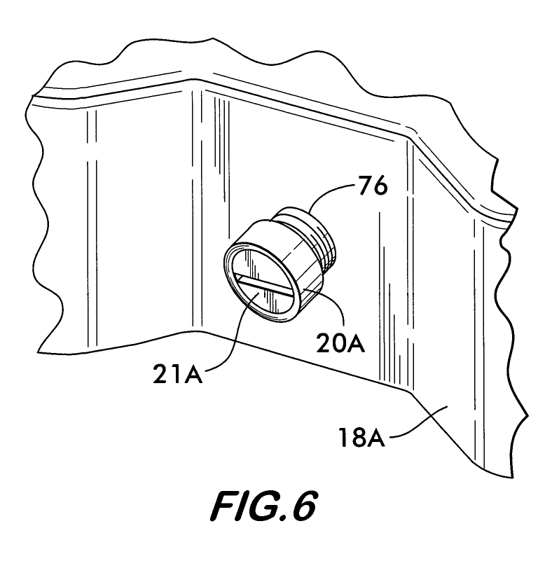

As can be seen in FIG. 6, in an alternate embodiment of the nozzle configuration, in its most simple form, the flow control device 20A may merely a threaded hole 76 in the body of the brush 18A that is in fluid connection with the brush hose fitting (not shown in FIG. 6) such that any liquid passing from the brush hose fitting to the threaded hole exits from the threaded hole 76. The threaded hole 76 receives one of at least two different nozzle outlet plugs, a plug for high pressure water 21A, and another plug for low pressure liquid (not shown) from the vessel 12. These nozzles provide similar pressures to the low high pressure positions 58A, 58B and the multiple low pressure positions 58C, 58D of the embodiment of FIGS. 1-5.

Optionally, as shown in FIG. 1, a pressure relief valve 72 may be included on the vessel 12 to protect the user and the vessel 12. Once a predetermined pressure exists within the vessel 12, for example, 35 psi, the pressure relief valve 72 relieves any excess pressure.

A valve 74 for user control of flow of liquid through the nozzle, as well known in the art of hose nozzles may also be included. For example, here, a locking trigger style valve, mounted on or adjacent to the handle 34 may be included.

The pump 14 may be, for example, a manually powered or electrically powered air pump that provides sufficient pressure to move liquid from the vessel 12, through the hose 16, and through the nozzle 19 to spray on a car.

Finally, when using the vessel 12, water alone may be the liquid contained in the vessel, or a water-based cleaning solution may be used.

Flowrates for use of the device 10 with both a vessel 12 and a high pressure water source 33 are preferably in the range of about 0.4 gallons per minute, at 40 psi, (˜1.6 liters per minute at 3 bars) to about 0.8 gallons per minute at 40 psi (3.2 liters per minute at 3 bars).

While the invention has been described in detail and with reference to specific embodiments thereof, it will be apparent to one skilled in the art that various changes and modifications can be made therein without departing from the spirit and scope thereof.

1. A car wash device, comprising:
(a) a vessel for holding a liquid;
(b) a pump to pressurize the vessel;
(c) a brush having a nozzle, said nozzle sealingly connected to a brush hose fitting;
(d) a hose having a first end and a second end, wherein
(i) said first end of said hose sealingly matable to the brush hose fitting; and
(ii) said second end of said hose is sealingly mated to the vessel; and
(e) a flow control device for controlling flow of the liquid through the nozzle having at least a low pressure position for use when the hose is mated to the vessel;
whereby the liquid is pressurized by the pump to cause the liquid to flow from the vessel through the hose and through the nozzle.

2. The car wash device of claim 1, wherein the brush has a hollow elongate handle.

3. The car wash device of claim 2, wherein the nozzle is sealingly connected to the hollow elongate handle at a first end of the elongate handle, and the brush hose fitting is located at a second end of the elongate handle.

4. The car wash device of claim 1, wherein the flow control device is integral to the nozzle.

5. The car wash device of claim 1, wherein the vessel has a pressure relief valve.

6. The car wash device of claim 1, where the flow control device has a plurality of detent positions for different flow pressures.

7. The car wash device of claim 1, including a valve for controlling flow of liquid through the nozzle.

8. The care wash device of claim 1, wherein the nozzle has a plurality of selectable nozzle shapes for selection of a nozzle flow pattern exiting the nozzle.

9. The car wash device of claim 8, wherein the nozzle has a rotatable selector disk that provides for selection of one of the nozzle shapes.

10. The car wash device of claim 1, wherein the pump is a manually powered air pump.

11. The car wash device of claim 1, wherein the pump is an electric pump.

12. The car wash device of claim 1, wherein the flow control device comprises a hole in the brush that is matable to one of a plurality of plugs having an orifice.

13. A car wash device, comprising:
(a) a vessel for holding a liquid;
(b) a pump to pressurize the vessel;
(c) a brush having a nozzle, said nozzle sealingly connected to a brush hose fitting;
(d) a hose having a first end and a second end, wherein
(i) said first end of said hose has a first hose fitting that is detachably and sealingly matable to the brush hose fitting; and
(ii) said second end of said hose is sealingly mated to the vessel;
(e) said brush hose fitting is sealingly matable to both the first hose fitting and a high pressure water source hose fitting; and
(f) a flow control device for controlling flow of the liquid through the nozzle having at least a low pressure position for use when the hose is mated to the vessel and a high pressure position when the hose is mated to the high pressure water source hose fitting;
whereby, when the brush hose fitting is mated to the first hose fitting of the hose, the liquid is pressurized by the pump to cause the liquid to flow from the vessel through the hose and through the nozzle when the flow control device is in the low pressure position and whereby, when the brush hose fitting is mated to the high pressure water source hose fitting, water flows from the high pressure water source through the hose and through the nozzle when the flow control device is in the high pressure position.

14. The car wash device of claim 13, wherein the brush has a hollow elongate handle.

15. The car wash device of claim 14, wherein the nozzle is sealingly connected to the hollow elongate handle at a first end of the elongate handle, and the brush hose fitting is located at a second end of the elongate handle.

16. The car wash device of claim 13, wherein the flow control device is integral to the nozzle.

17. The car wash device of claim 13, wherein the vessel has a pressure relief valve.

18. The car wash device of claim 13, where the flow control device has a plurality of detent positions to select either the high pressure position or the low pressure position.

19. The car wash device of claim 13, including a valve for controlling flow of liquid through the nozzle.

20. The care wash device of claim 13, wherein the nozzle has a plurality of selectable nozzle shapes for selection of a nozzle flow pattern exiting the nozzle.

21. The car wash device of claim 20, wherein the nozzle has a rotatable selector disk that provides for selection of one of the nozzle shapes.

22. The car wash device of claim 13, wherein the pump is a manually powered air pump.

23. The car wash device of claim 13, wherein the pump is an electric pump.

24. The car wash device of claim 13, wherein the flow control device comprises a hole in the brush that is matable to one of a plurality of plugs having an orifice, said plurality of plugs including at least a low pressure plug for use when the hose is mated to the vessel and a high pressure plug for use when the hose is mated to the high pressure water source hose fitting.

25. A brush for a car wash device, comprising a body, a nozzle, said nozzle sealingly connected to a brush hose fitting, and a flow control device for controlling flow of a liquid for washing a car through the nozzle.

26. The brush of claim 25, wherein the flow control device has at least a low pressure position and a high pressure position.

27. The brush of claim 25, wherein the nozzle provides for a flowrate in the range of about 0.4 gallons per minute at 40 psi to about 0.8 gallons per minute at 40 psi.

28. The brush of claim 25, wherein the brush has a hollow elongate handle.

29. The brush of claim 25, wherein the nozzle is sealingly connected to the hollow elongate handle at a first end of the elongate handle, and a brush hose fitting is located at a second end of the elongate handle.

30. The brush of claim 25, wherein the flow control device is integral to the nozzle.

31. The brush of claim 25, where the flow control device has a plurality of detent positions.

32. The brush of claim 25, including a valve for controlling flow of liquid through the nozzle.

33. The brush of claim 25, wherein the nozzle has a plurality of selectable nozzle shapes for selection of a nozzle flow pattern exiting the nozzle.

34. The brush of claim 33, wherein the nozzle has a rotatable selector disk that provides for selection of one of the nozzle shapes.

35. The brush of claim 25, wherein the flow control device comprises a hole in the brush that is matable to one of a plurality of plugs having an orifice,

36. The brush of claim 35, wherein said plurality of plugs includes at least a low pressure plug and a high pressure plug.
